(19) United States
(12) Patent Application Publication
(10) Pub. No.: US 2020/0364825 A1
(43) Pub. Date: Nov. 19, 2020

(54) METHOD FOR DEFORMING AN SELECTED ZONE OF IMAGE

(71) Applicant: NDSOFT Co., Ltd., Busan (KR)

(72) Inventor: Namdo PARK, Busan (KR)

(73) Assignee: NDSOFT Co., Ltd.

(21) Appl. No.: 16/714,815

(22) Filed: Dec. 16, 2019

(30) Foreign Application Priority Data
May 14, 2019 (KR) 10-2019-0056292

(51) Int. Cl. G06T 3/00

(52) U.S. Cl. CPC G06T 3/00; G06F 3/04842; G06T 2200/24

(57) ABSTRACT

Provided is a method of transforming a specific area of an image using a computer processor, the method comprising: receiving an input by the computer processor, wherein the input includes a xy starting point coordinate, a xy end point coordinate, and a vector direction extending from the xy starting point coordinate to the xy end point coordinate; defining, by the computer processor, a predetermined area around the xy starting point coordinate as a transformation area; and repeatedly moving back and forth in the vector direction, by the computer processor, the transformation area between the xy starting point coordinate and the xy end point coordinate.

### CROSS REFERENCE TO RELATED APPLICATIONS

This application claims priority to Korean Application No. 10-2019-0056292 filed on May 14, 2019, the entire contents of which are herein incorporated by reference in its entirety.

### TECHNICAL FIELD

The present invention relates to a method of transforming a specific area of an image. More particularly, it relates to a method of transforming a specific area of an image (e.g., a photo) displayed on a user terminal such as a computer, a smartphone, and a tablet.

### BACKGROUND OF INVENTION

In general, image transformation techniques include 2D image transformation techniques and 3D image transformation techniques. Image transformation techniques are used in various fields. Image transformation techniques have been developed as technology improves.

The patent application No. PCT/CN2017/080822 filed on Apr. 17, 2017, which is entitled “method and device for image warping processing and computer storage medium” discloses a method of transforming an image. According to PCT/CN2017/080822, five-sense reference points are located from a face image; a transformation template is obtained, wherein the transformation template carries configuration reference points and configuration guide points; current reference points and to-be-matched reference points are obtained, wherein the current reference points correspond to the configuration reference points, wherein the to-be-matched guide points correspond to the configuration guide points; five-sense reference similarity mapping is performed based on a locational relationship between the configuration reference points and the configuration guide points and a locational relationship between the current reference points and the to-be-matched reference points; target reference points, which correspond to the configuration reference points, are obtained from the face image; the to-be-matched reference points, which correspond to the target reference points, are defined as mapping points; a mapping relationship of to-be-processed points of the face image is determined based on a locational relation between the target reference points and the to-be-matched reference points and a locational relation between the mapping points and the to-be-processed points of the face image; and the to-be-processed points are mapped at target locations according to the mapping relationship.

The transformation template has its own configuration reference points and configuration guide points. The transformation template first obtains five-sense similarity mapping target references from the face image via the current reference points and the to-be-matched reference points, and then determines the mapping relationship of the to-be-processed points of the face image. The to-be-processed points of the face image are mapped at corresponding target locations to automatically determine a transformation size and evaluate a matching degree between a target image and a transformed image.

However, the above mentioned method is designed for transforming a person's face and is not applicable to another field in general.

Prior Art Information: PCT/CN2017/080822 filed on Apr. 17, 2017, which is entitled “method and device for image warping processing and computer storage medium.”

### DETAILED DESCRIPTION OF INVENTION

### Problems to be Solved

The present invention provides a method for transforming a specific area of a given image. The present provides a method of transforming a 2D image.

The present invention provides a method of transforming a 2D image (e.g., photo image) displayed on all kinds of terminals having a display unit, such as a computer, a smartphone, and a tablet.

An objective of the present invention is to provide a method of selecting a specific area from a 2D image displayed on a terminal and then transforming the specific area for a predetermined time.

An objective of the present invention is to provide a method of selecting a specific area from a 2D image using a function key or a touch method and making the selected specific area transformed for a predetermined time.

SUMMARY OF INVENTION

A method of transforming a specific area of an image using a computer processor is provided. In an embodiment, the method comprises: receiving an input by the computer processor, wherein the input includes a xy starting point coordinate, a xy end point coordinate, and a vector direction extending from the xy starting point coordinate to the xy end point coordinate; setting, by the computer processor, a predetermined area around the xy starting point coordinate to a transformation area; and repeatedly moving back and forth, by the computer processor, the transformation area between the xy starting point coordinate and the xy end point coordinate in the vector direction.

In another embodiment, the method comprises: receiving an input by the computer processor, wherein the input includes a xy starting point coordinate, N number of xy end point coordinates, and N number of vector directions respectively extending from the xy starting point coordinate to the N number of xy end point coordinates, wherein N is an integer, wherein a Nth distance from the xy starting point coordinate to an Nth xy end point coordinate is shorter than a (N-1)th distance from the xy starting point coordinate to an (N-1)th xy end point coordinate; setting, by the computer processor, a predetermined area around the xy starting point coordinate to a transformation area; and repeatedly moving, by the computer processor, the transformation area back and forth N number of times between the xy starting point coordinate and the N number of end point ordinates respectively along the N number of vector directions.

The method may further comprises: stopping moving the transformation area back and forth when the Nth end point cordinate coincides with the xy starting point coordinate.

### Advantages of Invention

A method of transforming a specific area of a image according to an embodiment of the present invention may provide advantages as follows. A specific area of an image displayed on a terminal can be easily transformed for a predetermined time. The image transformation technique proposed in the present invention may be performed on a user terminal. With this technique, a 2D image can be transformed in various ways. A user may make a fun using this method.

### BRIEF DESCRIPTION OF DRAWINGS

FIG. 1 is an example of a 2D image displayed on a user terminal.

FIGS. 2(A) and 2(B) show transformation areas selected from images. The transformation areas selected are subject to image transformation according to the present invention.

FIG. 3 shows a back and forth movement of the transformation area selected. The movement distances are getting shorter and shorter over a time passage.

### EMBODIMENTS

Hereinafter, a method of transforming a specific area of an image according to embodiments of the present invention will be described with reference to the drawings.

A program or an application implementing a method according to the present invention may be installed on a user terminal such as a computer, a smartphone, or a tablet, etc. In another embodiment, the program or the application can be installed on a server which is wirelessly connected with the user terminal.

First, a 2D image (e.g., a picture) is loaded onto a user terminal. Hereinafter, the 2D image may be referred to as an “image.” In the present invention, the term “loaded” includes an act of loading a 2D image on an application program (also referred to as app) which is installed on a computer or a server.

Next, a specific area of the 2D image is selected. Selection of the specific area of the 2D image may be made by a function key or a touch method. The function key may be provided by an application which is installed on a user terminal. The touch method may be executed by touching a display unit of a user terminal. In the present invention, the specific area is the area which is subject to image transformation.

When the selection of the specific area is made by the function keys provided by the application, the specific area may be defined as a circle with a predetermined radius. In another embodiment, the specific area may be defined in a polygon shape such as a triangle, a rectangle, etc.

When the selection of the specific area (also referred to as a transformation area) is made by a touch method, a touch is made on a first location (xy starting point coordinate) of the 2D image displayed on a display unit of the user terminal; the touch is dragged by a predetermined distance to a second location (xy end point coordinate); and then the touch is off at the second location. By doing so, the xy starting point coordinate and the xy end point coordinate are determined, and the specific area is defined which is subject to transformation.

That is, the first touch location becomes the xy starting point coordinate, and the location where the touch is off becomes the xy end point coordinate. The xy starting point coordinate and the xy end point coordinate are stored by the application.

The touch is off the display unit after being dragged on the display unit in a predetermined direction by a predetermined distance. The dragging distance and the dragging direction are determined by the xy starting point coordinate and the xy end point coordinate. The dragging direction becomes a vector direction.

The vector direction refers a transformation direction of the specific area selected. When the xy starting point coordinate and the xy end point coordinate are determined, the transformation area (e.g., a circle) is defined. The distance between the two coordinates becomes a diameter of the transformation area.

In an embodiment, when a finger drags from A coordinate (xy starting point coordinate) to B coordinate (xy end point coordinate) in a predetermined direction, a circle is defined. A diameter of the circle is the distance between A-B, The A coordinate and the B coordinate are located on the circumference of the circle. The circle repeatedly moves back and forth along the vector direction by a predetermined distance, thereby making the image is displayed as transformed.

In another embodiment of the present invention, the moving distance of the specific area may be getting shorter and shorter as time passes by. The back and forth movement of the transformation area may terminate when the xy end point coordinate coincides with the xy starting point of coordinate. The present invention, however, is not limited thereto.

In a further another embodiment, the back and forth movement of the transformation area may terminate when the xy end point coordinate arrives at a predetermined location between the xy starting point coordinate and the xy end point of coordinate.

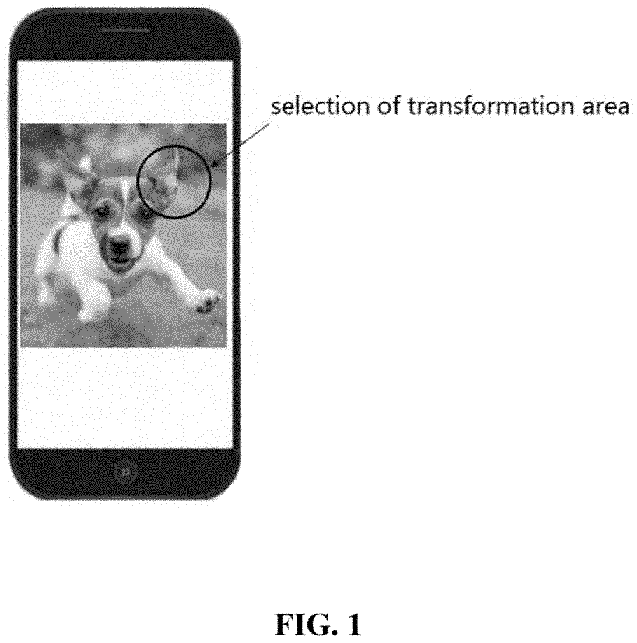

Referring to the drawings, the image transformation method according to the present invention will be described hereinafter. FIG. 1 is an example of a 2D image displayed on a user terminal. FIG. 1 shows a specific area which is selected for transformation. Selection of the specific area may be made using a function key provided by an application or using a touch method.

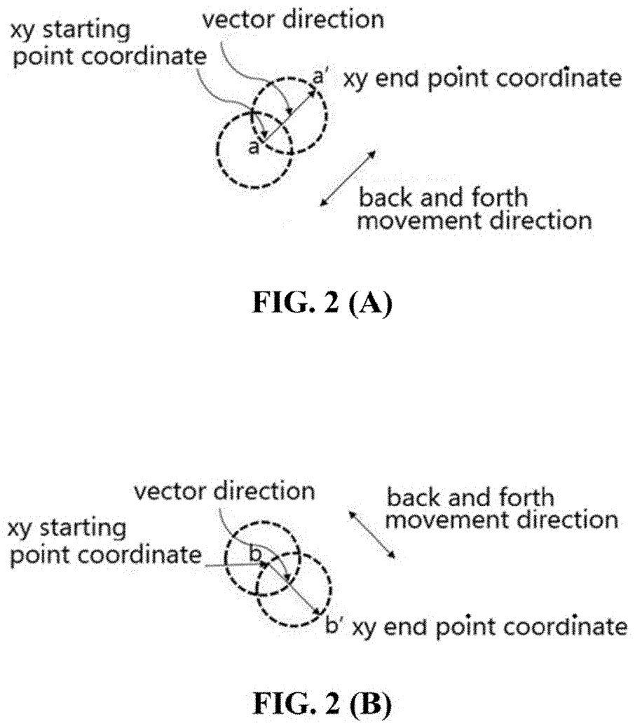

Referring to FIG. 2, the specific area (transformation area) selected from the image is made by a touch method. Referring to (A) and (B) of FIG. 2, a user touches a display unit of a user terminal with his finger and drags the finger in a predetermined direction. Thereby, a xy starting point coordinate (a, a′), a xy end point coordinate (b, b′), and a drag direction (vector direction) are determined. As a result, a circle is defined. The drag distance is set to a diameter of the circle.

In FIG. 2, the symbol ⇄ represents the direction in which the selected specific area moves back and forth between the xy starting point coordinate and the xy end point coordinate.

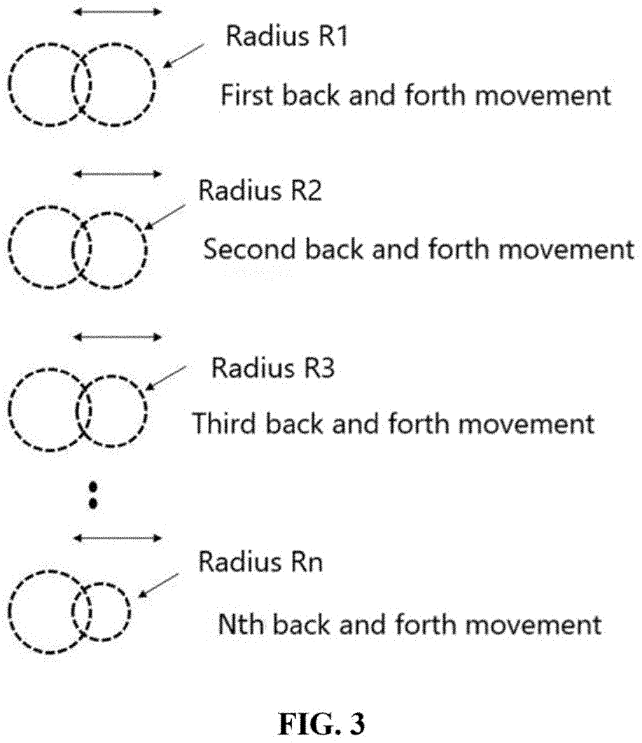

Referring to FIG. 3, the selected circle area repeats the back and forth movement. A radius (or a diameter) of the selected circle area is getting shorter and shorter over a time passage.

As shown in FIG. 3, at the first round of back and forth movement, the radius of the selected circle area is R1. The radius (R2, R3, . . . RN) of the selected circle area reduces gradually at the 2nd, the 3rd, . . . , and the Nth round trip. Here, N is an integer and R1>R2>R3, . . . >RN.

The above-described embodiment can be implemented through an application installed on a user terminal. The application can be linked with a server. The image transformation method according to the present invention may be combined with an acceleration sensor of the user terminal.

In an embodiment, a given image is displayed on an application, and a specific area of the given image is selected. When acceleration caused by a dragging motion is above a predetermined threshold, the acceleration sensor of the terminal may take the dragging motion as an execution command. Then, as shown in FIGS. 2 and 3, the selected specific area is transformed according to pre-set conditions of the application.

The above mentioned embodiments are provided for illustrative purposes. It should be understood that the present invention is not limited to the above mentioned embodiments.

What is claimed is:

1. A method of transforming a specific area of an image using a computer processor, the method comprising:
receiving an input by the computer processor, wherein the input includes a xy starting point coordinate, a xy end point coordinate, and a vector direction extending from the xy starting point coordinate to the xy end point coordinate;
defining, by the computer processor, a predetermined area around the xy starting point coordinate as a transformation area; and
repeatedly moving back and forth in the vector direction, by the computer processor, the transformation area between the xy starting point coordinate and the xy end point coordinate.

2. A method of transforming a specific area of an image using a computer processor, comprising:
receiving an input by the computer processor, wherein the input includes a xy starting point coordinate, N number of xy end point coordinates, and N number of vector directions respectively extending from the xy starting point coordinate to the N number of xy end point coordinates, wherein N is an integer, wherein a Nth distance measured from the xy starting point coordinate to an Nth xy end point coordinate is shorter than a (N-1)th distance measured from the xy starting point coordinate to an (N-1)th xy end point coordinate;
defining, by the computer processor, a predetermined area around the xy starting point coordinate as a transformation area; and
repeatedly moving back and forth in the N number of vector directions, by the computer processor, the transformation area between the xy starting point coordinate and the N number of end point ordinates.

3. The method of claim 2, the method further comprising:
stopping moving the transformation area back and forth when the Nth end point cordinate coincides with the xy starting point coordinate.
